(19) United States
(12) Patent Application Publication
(10) Pub. No.: US 2012/0289447 A1
(43) Pub. Date: Nov. 15, 2012

(54) LIQUID DETERGENT FORMULATION CONTAINING ENZYME AND PEROXIDE IN A UNIFORM LIQUID

(75) Inventor: Steven T. ADAMY, Lawrenceville, NJ (US)

(73) Assignee: CHURCH & DWIGHT CO., INC., Princeton, NJ (US)

(21) Appl. No.: 13/104,099

(22) Filed: May 10, 2011

(51) Int. Cl. C11D 7/60; C11D 3/60

(52) U.S. Cl. 510/304; 510/303

(57) ABSTRACT

A stable, liquid bleach composition is disclosed. The composition comprises a peroxide-component, an enzyme component, and a solvent.

### FIELD OF THE INVENTION

This invention relates to novel liquid cleaning detergent compositions containing enzyme and peroxide.

### BACKGROUND OF THE INVENTION

Hydrogen peroxide solutions have been used for many years for a variety of purposes, including bleaching, disinfecting, and cleaning a variety of things and surfaces ranging from skin, hair, and mucous membranes to contact lenses to household and industrial surfaces and instruments. In particular, inorganic peroxygen compounds, especially hydrogen peroxide and solid peroxygen compounds which dissolve in water to release hydrogen peroxide, such as sodium perborate and sodium carbonate perhydrate, have long been used as oxidizing agents for purposes of disinfection and bleaching, and the benefits of employing peroxide for the removal of laundry stains are well-known. Hydrogen peroxide and the precursors which liberate it in solution are good oxidizing agents for removing certain stains from cloth, especially stains caused by red wine, tea, coffee, cocoa, fruits, materials composed of anthocyanin compounds, etc.

Detersive enzymes represent an alternative to chlorine and organochlorines, and these enzymes have been employed in cleaning compositions since early in the 20th century. However, it took years of research, until the mid 1960's, before enzymes like bacterial alkaline proteases were commercially available and which had all of the minimum pH stability and soil reactivity for detergent applications. Patents issued through the 1960s related to use of enzymes for consumer laundry pre-soak or wash cycle detergent compositions and consumer automatic dishwashing detergents. Early enzyme cleaning products evolved from simple powders containing alkaline protease to more complex granular compositions containing multiple enzymes to liquid compositions containing enzymes. See, for example, U.S. Pat. No. 3,451,935 to Roald et al., issued Jun. 24, 1969 and U.S. Pat. No. 3,519,570 to McCarty issued Jul. 7, 1970. Enzymes are particularly effective against classes of stains, such as proteinacious (blood), fatty (food grease), and starchy (pasta) stains, that are not particularly treated by the use of hydrogen peroxide solutions.

It is particularly advantageous to incorporate both enzymes and peroxides into a single composition so that the benefits of both stain-removing mechanisms could be realized; however, the incorporation of some ingredients into detergent compositions is problematic. Detergent compositions are often stored for some time and interactions may occur between active components such that a reduction in the amount of the active component may result. This can be particularly problematic in compositions containing both enzymes and peroxides. Unfortunately, enzymes and peroxides are typically known to be incompatible with each other when placed in a single liquid formulation. Peroxides destroy enzymes, and the pH range at which most laundry enzymes are most stable (about 6 to 9) poses stability problems for hydrogen peroxide. Previous attempts to incorporate both enzymes and peroxides into a single composition have been in solid form. For example, U.S. Pat. No. 5,108,742 describes a stable, uniform, free flowing, fine, white powder of an anhydrous complex of PVP and H₂O₂. However, the prior art does not describe how to make a stable, liquid detergent composition that contains both enzymes and peroxide.

While the prior art describes solid forms of compositions containing both peroxides and enzymes, liquid detergent compositions offer several advantages over solid compositions. For example, liquid compositions are easier to measure and dispense. Additionally, liquid compositions are especially useful for direct application to heavily soiled areas on fabrics, after which the pre-treated fabrics can be placed in an aqueous bath for laundering in the ordinary manner. In addition, liquid detergent compositions containing enzymes have advantages compared to dry powder forms. Enzyme powders or granulates tend to segregate in these mechanical mixtures resulting in non-uniform, and hence undependable, product in use. In dry compositions, humidity can cause enzyme degradation. Dry powdered compositions are not as conveniently suited as liquids for rapid solubility or miscibility in cold and tepid waters nor functional as direct application products to soiled surfaces. For these reasons and for expanded applications, it is desirable to have liquid detergent compositions.

Unfortunately, unless very stringent conditions are met, hydrogen peroxide solutions begin to decompose into O₂ gas and water within an extremely short time. Typical hydrogen peroxide solutions in use for these purposes are in the range of from about 0.5 to about 6% by weight of hydrogen peroxide in water. The rate at which such dilute hydrogen peroxide solutions decompose will, of course, be dependent upon such factors as pH and the presence of trace amounts of various metal impurities, such as copper or chromium, which may act to catalytically decompose the same. Moreover, at moderately elevated temperatures, the rate of decomposition of such dilute aqueous hydrogen peroxide solutions is greatly accelerated.

In addition to concerns about hydrogen peroxide decomposition, enzymes can denature or degrade in a liquid medium resulting in the serious reduction or complete loss of enzyme activity. Enzymes have three-dimensional protein structure which can be physically or chemically changed by other solution ingredients, such as peroxides, causing loss of catalytic effect.

In order to market a liquid detergent composition containing both peroxide and enzymes, the composition must be stabilized so that it will retain its functional activity for prolonged periods of shelf-life and/or storage time. If a stabilized system is not employed, an excess of enzyme is generally required to compensate for expected loss due to degeneration caused by the peroxide. However, enzymes are expensive and are in fact the most costly ingredients in a commercial detergent even though they are present in relatively minor amounts. There remains a need for a method and composition for stabilizing enzymes in liquid cleaning compositions, particularly liquid cleaning compositions containing a peroxide.

### SUMMARY OF THE INVENTION

The objective of this invention is to develop a stable, liquid detergent composition that contains a peroxide-based agent, a detersive enzyme, and a solvent. It has been surprisingly found that homogenous liquid compositions containing an enzyme and a stable hydrogen peroxide can be formulated into a largely anhydrous, stable liquid matrix.

### DETAILED DESCRIPTION OF THE INVENTION

The objective of this invention is to develop a stable, liquid detergent composition that contains a peroxide-based agent, a detersive enzyme, and a solvent. Current detergents that contain both a peroxide and an enzyme are in solid form or suspension form. For example, WO 2007/035009 describes a suspension composition containing both a peroxide and an enzyme.

It has been surprisingly found that homogenous liquid compositions containing an enzyme and a stable hydrogen peroxide, such as polyvinylpyrrolidone peroxide, can be formulated into a largely anhydrous liquid matrix. The compositions show good enzyme and peroxide stability. Advantageously, the liquid compositions are translucent and uniform.

The liquid compositions according to this invention have chemical and physical stabilities during the storage and can be used as, for example, a cleaning composition to remove stains on clothes.

### Peroxide

The peroxide component of the liquid detergent compositions used in the present invention may be a stable H₂O₂ composition. H₂O₂ compositions may be stabilized by binding the H₂O₂ to an organic ligand, such as polyvinylpyrrolidone.

For example, Shiraeff, in U.S. Pat. Nos. 3,376,110 and 3,480,557, disclosed that a solid, stabilized hydrogen peroxide composition of hydrogen peroxide and a polymeric N-vinyl heterocyclic compound could be prepared from an aqueous solution of the components. The process involved mixing PVP and a substantial excess of aqueous H₂O₂ and evaporating the solution to dryness. The H₂O₂ content of the composition was given as being at least 2%, and preferably 4.5 to 70% by weight. Prolonged drying of the composition, in an attempt to reduce the water content, however, resulted in a substantial loss of H₂O₂ from the complex. The product was a brittle, transparent, gummy, amorphous material, and had a variable H₂O₂ content ranging from about 3.20 to 18.07% by weight, depending upon the drying times. In addition, U.S. Pat. No. 5,077,047 describes a process for the production of PVP-H₂O₂ products in the form of free-flowing powders.

The preferred peroxide components employed for the present invention are classified broadly as stable hydrogen peroxide compositions. Preferred examples include adducts of a peroxide and an organic material, such as PVP-H₂O₂, urea peroxide, or urea-hydrogen peroxide-polyvinylpyrrolidone. Typical amounts of PVP-H₂O₂ peroxide used are from 0.001% to 50%, preferably 0.1 to 20%, by weight of the enzyme preparation.

It has also been surprisingly found that a small amount of water, up to about 10%, could be tolerated in the present invention such that the liquid composition remains stable over an extended period of time. Thus, the stable peroxide composition used in the present invention could also be in liquid form where the hydrogen peroxide is stabilized with a number of ingredients, such as stannates, other chelators, phosphonates, etc. For example, PB33 (manufactured by Eka Chemical) is a hydrogen peroxide at a level of 33% in water and was used as the peroxide component in the present invention and both the peroxide and enzyme activity levels remained stable over an extended period of time, see Example 6 below. Typical amounts of a liquid H₂O₂ peroxide used are from 0.001% to 20% by weight of the enzyme preparation.

### Enzymes

The compositions of the present invention include one or more detersive enzymes, either singly or in any combination of two or more, that can be dissolved into solution. Enzymes are included in the present detergent compositions for a variety of purposes, including removal of protein-based, carbohydrate-based, or triglyceride-based stains from substrates. Generally, suitable enzymes include cellulases, hemicellulases, proteases, gluco-amylases, amylases, lipases, cutinases, pectinases, xylanases, keratinases, reductases, oxidases, phenoloxidases, lipoxygenases, ligninases, pullulanases, tannases, chondriotinases, thermitases, pentosanases, malanases, β-glucanases, arabinosidases or mixtures thereof of any suitable origin, such as vegetable, animal, bacterial, fungal and yeast origin. Preferred enzymes for use in the present invention are dictated by factors such as formula pH, thermostability, and stability to surfactants, builders and the like. In this respect bacterial or fungal enzymes are preferred, such as bacterial amylases and proteases, and fungal cellulases. A preferred combination is a detergent composition having a mixture of conventional detergent enzymes like protease, amylase, lipase, cutinase and/or cellulase. Suitable enzymes are also described in U.S. Pat. Nos. 5,677,272, 5,679,630, 5,703,027, 5,703,034, 5,705,464, 5,707,950, 5,707,951, 5,710,115, 5,710,116, 5,710,118, 5,710,119 and 5,721,202.

Enzymes are normally incorporated into detergent compositions at levels sufficient to provide a “cleaning-effective amount”. The term “cleaning effective amount” refers to any amount capable of producing a cleaning, stain removal, soil removal, whitening, deodorizing, or freshness improving effect on substrates such as fabrics, dishware and the like. In practical terms for current commercial preparations, typical amounts are typically from 0.001% to 10% by weight of a commercial enzyme preparation. Protease enzymes are usually present in such commercial preparations at levels sufficient to provide from 0.005 to 0.1 Anson units (AU) of activity per gram of composition. For certain detergents it may be desirable to increase the active enzyme content of the commercial preparation in order to minimize the total amount of non-catalytically active materials and thereby improve spotting/filming or other end-results.

Higher active levels may also be desirable in highly concentrated detergent formulations. Proteolytic enzymes can be of animal, vegetable or microorganism (preferred) origin. The proteases for use in the detergent compositions herein include (but are not limited to) trypsin, subtilisin, chymotrypsin and elastase-type proteases. Preferred for use herein are subtilisin-type proteolytic enzymes. Particularly preferred is bacterial serine proteolytic enzyme obtained from Bacillus subtilis and/or Bacillus licheniformis. Suitable proteolytic enzymes include Novo Industri A/S Alcalase®, Esperase®, Savinase® (Copenhagen, Denmark), Gist-brocades' Maxatase®, Maxacal® and Maxapem 15® (protein engineered Maxacal®) (Delft, Netherlands), and subtilisin BPN and BPN′ (preferred), which are commercially available. Preferred proteolytic enzymes are also modified bacterial serine proteases, such as those made by Genencor International, Inc. (San Francisco, Calif.), which are described in U.S. Pat. Nos. 5,972,682, 5,763,257 and 6,465,235 and which are also called herein “Protease B”. U.S. Pat. No. 5,030,378, Venegas, issued Jul. 9, 1991, refers to a modified bacterial serine proteolytic enzyme (Genencor International), which is called “Protease A” herein (same as BPN′). In particular, see columns 2 and 3 of U.S. Pat. No. 5,030,378 for a complete description, (including the amino sequence), of Protease A and its variants. Other proteases are sold under the tradenames: Primase®, Durazym®, Opticlean® and Optimase®. Preferred proteolytic enzymes, then, are selected from the group consisting of Alcalase® (Novo Industri A/S), BPN′, Protease A and Protease B (Genencor), and mixtures thereof. Protease B is most preferred. The compositions of the present invention will preferably contain at least about 0.0001% by weight of the composition of enzyme. Although proteases may be used alone, it is preferable to have a combination of protease and amylase, or a combination of protease, lipase and amylase in the compositions of the present invention.

### Solvent

It has been surprisingly found that the detergent composition of the present invention could be in liquid form with the choice of the appropriate solvent. The appropriate solvent for the present invention is one that dissolves both the enzyme and peroxide components and produces a uniform liquid composition.

The choice of solvents for the present invention is best defined by considering the three dimensional solubility parameter of the composition. The solubility parameter δ is defined as the square root of the cohesive energy density associated with a material. The cohesive energy density characterizes the attractive strength between molecules of the material.

For the three attractive interactions between molecules, i.e. dispersive, polar, and hydrogen bonding, we can define separate solubility parameters, which subsequently relate to the attractive interactions associated with the three interactions. These parameters are:
δ_{d}=dispersive solubility parameter
δₚ=polar solubility parameter
δₕ=hydrogen-bonding solubility parameter

Using these three coordinates, a three-dimensional space can be defined (called the Hansen space). Thus, a material in that space is defined as a point with coordinates δ_{d}, δₚ, and δₕ.

In terms of choosing appropriate solvents to dissolve, for example, polyvinyl pyrrolidone peroxide, one can generally correlate behavior by considering the three solubility parameters associated with polyvinyl pyrrolidone-H₂O₂. The three solubility parameters for PVP-H₂O₂ are estimated at:
δ_{d}=18.8 (MPa)^{1/2}
δₚ=11.9 (MPa)^{1/2}
δₕ=31.1 (MPa)^{1/2}

The estimate is based on calculating the mole fractions of vinyl-pyrrolidone monomer and H₂O₂ in PVP-H₂O₂ polymer. Values of δ for vinylpyrrolidone and H₂O₂ were then weighted according to mole fraction to calculate weighted average values of δ.

Appropriate solvents for this material are chosen from materials which lie within a sphere in the Hansen space, defined by a radius R or less. In evaluating whether a solvent is appropriate the sphere radius may be calculated from:

R=[(δₚ₁−δₚ₂)²+(δₕ₁−δₕ₂)²+4(δ_{d1}−δ_{d2})²]^{1/2}

where 1 corresponds to values for PVP-H₂O₂ and 2 corresponds to values for the test solvent. In order to determine an estimate of R, 0.6 g of PVP-H₂O₂ (Peroxydone K-30 from ISP) was mixed with 12.2 g of a particular solvent at room temperature. The mixtures were vortex mixed for 10 seconds, and then periodically agitated to promote dissolution. Observations were recorded after about 1 hour, and then confirmed about 20 hours later. The following observations were made as to mixture appearance. The observations are compared with calculated values of R below:

TABLE 1
Solvent mixtures

| | | Calculated value of R |
|---|---|---|
| | Appearance of solution of | for PVP-H2O2 polymer |
| Solvent | PVP-H2O2 and solvent | and solvent |
| 1,2-butanediol | Clear solution | 10.0 |
| 1-pentanol | Clear solution | 18.4 |
| PEG (400 MW) | Clear solution | 20.2 |
| 1,2-hexanediol | Clear solution | 15.6 |
| Ethylene glycol | Clear solution | 20.2 |
| monobutyl ether | | |
| Diethylene glycol | Clear solution | 20.2 |
| monohexyl ether | | |
| Propylene carbonate | Hazy dispersion | 27.7 |
| Ethyl acetate | Polymer insoluble | 25.0 |

Based on the calculations above, solvents producing an R value less than 25, should be appropriate for solvating the polymer. It is interesting that propylene carbonate (R=27.7) produced a turbid system and use of ethyl acetate (R=25.0) resulted in a no suspension or dissolution at all (the solid polymer sat un-dissolved at the bottom of the tube). Therefore, the propylene carbonate could be said to have been a slightly better solvent than ethyl acetate. A possible explanation is that propylene carbonate possesses a smaller molar volume than ethyl acetate:
Vₘₒₗ propylene carbonate=85.0 cc/mole
Vₘₒₗ ethyl acetate=98.5 cc/mole

As discussed by Hansen (C. M. Hansen, Hansen Solubility Parameters, a User's Handbook, 2nd ed., CRC Press, Boca Raton, 2007, p. 7), it is sometimes possible that solvents that theoretically lie outside the solubility sphere (in the Hansen space) are able to dissolve corresponding polymers, and this is due to their small molecular size, and hence reduced molar volume. Indeed, the molar volume is sometimes used as a fourth parameter in considering appropriate solvents.

The data above suggests that solvents in the sphere of the Hansen space defined by R ˜23 (i.e. half way between 20 and 25) should be appropriate solvents. Other solvents that lie near the solubility sphere may be appropriate if they have a reduced molar volume. From the table above, appropriate solvents for dissolving PVP-peroxide may include for example, 1,2-butanediol, 1,2-hexanediol, ethylene glycol monobutyl ether, etc.

### The Builder Component

The liquid laundry detergent compositions of the present invention may also include at least one builder. Builders are well known in the laundry detergent art and include such species as hydroxides, carbonates, sesquicarbonates, bicarbonates, borates, citrates, silicates, zeolites, and such. Examples of builders for use in the present invention include but are not limited to sodium hydroxide (NaOH), potassium hydroxide (KOH), magnesium hydroxide (Mg(OH)₂), sodium carbonate (Na₂CO₃), potassium carbonate (K₂CO₃), sodium bicarbonate (NaHCO₃), potassium bicarbonate (KHCO₃), sodium sesquicarbonate (Na₂CO₃*NaHCO₃*2H₂O), sodium silicate (SiO₂/Na₂O), sodium borate (Na₂B₄O₇—(H₂O)₁₀ or “borax”), citric acid (C₆H₈O₇), monosodium citrate (NaC₆H₇O₇), disodium citrate (Na₂C₆H₆O₇), and trisodium citrate (Na₃C₆H₅O₇), and mixtures thereof. It should be understood that combinations of free acid materials (like citric acid) when combined with alkali such as sodium hydroxide can generate the mono-, di-, or trisodium salts of citric acid in situ. The preferred level of builder for use in these laundry detergents is from about 0% to about 5% by weight.

### Polymer Components

The compositions of the present invention may also include at least one soil dispersing and/or anti-redeposition or water conditioning polymers such as sodium polyacrylate, carboxymethylcellulose (CMC), or hydroxypropyl methylcellulose (HPMC). Particularly suitable polymeric polycarboxylates are derived from acrylic acid, and this polymer and the corresponding neutralized forms include and are commonly referred to as polyacrylic acid, 2-propenoic acid homopolymer or acrylic acid polymer, and sodium polyacrylate, 2-propenoic acid homopolymer sodium salt, acrylic acid polymer sodium salt, poly sodium acrylate, or polyacrylic acid sodium salt. Polyacrylates are “biodegradable”, however, the cellulosic materials such as CMC and HPMC may show a faster biodegradation profile and may be more preferred in keeping with the spirit of the eco-friendly character of the present invention.

### Adjuvant

Additional optional materials for use in the present detergents may include chelants such as tetrasodium ethylenediamine tetraacetate-EDTA, Triton® chelants from BASF, phosphates, zeolite, nitrilotriacetate (NTA) and it's corresponding salts, optical brighteners, dye fixatives or transfer inhibitors, perfumes, additional fragrance and fragrance masking agents to coordinate with the natural essences, odor neutralizers, dyes, pigments and colorants, solvents, cationic surfactants, other softening or antistatic agents, thickeners, emulsifiers, bleach catalysts, enzyme stabilizers, clays, surface modifying polymers, pH-buffering agents, abrasives, preservatives and sanitizers or disinfectants, anti-redeposition agents, opacifiers, anti-foaming agents, cyclodextrin, rheology-control agents, thickeners such as dihydroxyethyl tallow glycinate, vitamins and other skin benefit agents, nano-particles and encapsulated particles, visible plastic particles, visible beads, etc., and the like, and any combination of adjuvant.

A thickening agent may be used to prepare the stable liquid composition of the present invention. The thickening agent is selected from the group consisting of fatty acid, cross-linked acrylic acid copolymer, colloidal silica, carboxymethylcellulose, polyvinyl alcohol, polyvinyl pyrrolidone and sodium polyacryylate and a mixture thereof.

Hydrophilic fumed silica can be used as colloidal silica. The level of colloidal silica used is 0.01 to 5 wt. %. The viscosity of the liquid composition of the present invention can be adjusted by adjusting the amount of fumed silica used. Liquid compositions of the present invention can be formed in a lower viscosity liquid form having a viscosity lower than 5000 cps, preferably below 3000 cps. Such low viscosity solutions can be applied in an easy to use form, such as a spray.

### Surfactant

The bleach compositions of the present invention may contain at least one anionic or nonionic surfactant or a mixture of the two types of surfactant. Typically, such materials will be used at levels in the compositions from 0.25% to 30%, by weight

One or more nonionic surfactants may be included in the detergent of the present invention. Suitable nonionic surfactant compounds may fall into several different chemical types. Preferred nonionic surfactants are polyoxyethylene or polyoxypropylene condensates of organic compounds. Examples of preferred nonionic surfactants are:
(a) Polyoxyethylene or polyoxypropylene condensates of aliphatic carboxylic acids, whether linear- or branched-chain and unsaturated or saturated, containing from about 8 to about 18 carbon atoms in the aliphatic chain and incorporating from 5 to about 50 ethylene oxide or propylene oxide units. Suitable carboxylic acids include “coconut” fatty acid (derived from coconut oil) which contains an average of about 12 carbon atoms, “tallow” fatty acids (derived from tallow-class fats) which contains an average of about 18 carbon atoms, palmitic acid, myristic acid, stearic acid and lauric acid;
(b) Polyoxyethylene or polyoxypropylene condensates of aliphatic alcohols, whether linear- or branched-chain and unsaturated or saturated, containing from about 8 to about 24 carbon atoms and incorporating from about 5 to about 50 ethylene oxide or propylene oxide units. Suitable alcohols include the “coconut” fatty alcohol (derived from coconut oil), “tallow” fatty alcohol (derived from the tallow-class fats), lauryl alcohol, myristyl alcohol, and oleyl alcohol.

The contemplated water soluble anionic detergent surfactants are the alkali metal (such as sodium and potassium) salts of the higher linear alkyl benzene sulfonates and the alkali metal salts of sulfated ethoxylated and unethoxylated fatty alcohols, and ethoxylated alkyl phenols. The particular salt will be suitably selected depending upon the particular formulation and the proportions therein.

The sodium alkybenzenesulfonate surfactant (LAS), if used in the composition of the present invention, preferably has a straight chain alkyl radical of average length of about 11 to 13 carbon atoms. Specific sulfated surfactants which can be used in the compositions of the present invention include sulfated ethoxylated and unethoxylated fatty alcohols, preferably linear primary or secondary monohydric alcohols with C₁₀-C₁₈, preferably C₁₂-C₁₆, alkyl groups and, if ethoxylated, on average about 1-15, preferably 3-12 moles of ethylene oxide (EO) per mole of alcohol, and sulfated ethoxylated alkylphenols with C₈-C₁₆ alkyl groups, preferably C₈-C₉ alkyl groups, and on average from 4-12 moles of EO per mole of alkyl phenol.

Anionic surfactants are well known to those skilled in the art. Typical anionic surfactants include sulfates and sulfonate salts, such as C₈ to C₁₂ alkylbenzene sulfonates, C₁₂ to C₁₆ alkane sulfonates, C₁₂ to C₁₆ alkyl sulfates, C₁₂ to C₁₆ alkylsulfosuccinates, and sulfates of ethoxylated and propoxylated alcohols, such as those described above. Typical anionic surfactants include, for example, sodium cetyl sulfate, sodium lauryl sulfate, sodium myristyl sulfate, sodium stearyl sulfate, sodium dodecylbenzene sulfonate, and sodium polyoxyethylene lauryl ether sulfate. Sodium lauryl (dodecyl) sulfate (SLS) is commonly used in cleaning agents.

### EXAMPLES

### Example 1

With the necessary and optional ingredients thus described, exemplary embodiments of the liquid laundry detergent compositions of the present invention, with each of the components set forth in weight percent actives (i.e., theoretical amounts after blending), are shown in Table 2.

TABLE 2
Formulations of peroxide/enzyme containing liquid detergents

| | Composition Number | | | | | | | |
|---|---|---|---|---|---|---|---|---|
| | 1 | 2 | 3 | 4 | 5 | 6 | 7 | 8 |
| Fumed silica | 3.50 | 3.50 | 3.50 | 3.50 | 3.50 | 3.50 | 3.50 | 3.50 |
| Hydroxypropyl | 1.00 | 1.00 | 1.00 | 1.00 | 1.00 | 1.00 | 1.00 | 1.00 |
| methylcellulose | | | | | | | | |
| Na₂CO₃* | 10.0 | 10.0 | 0 | 0 | 10.0 | 10.0 | 0 | 0 |
| 1.5H₂O₂ | | | | | | | | |
| PVP*H₂O₂ | 0 | 0 | 5.60 | 5.60 | 0 | 0 | 5.60 | 5.60 |
| (about 18% | | | | | | | | |
| H₂O₂₎ | | | | | | | | |
| Purafect OX | 0.25 | 1.00 | 0.25 | 1.00 | 0 | 0 | 0 | 0 |
| 4000 (enzyme | | | | | | | | |
| granules) | | | | | | | | |
| Purafect | 0 | 0 | 0 | 0 | 0.25 | 1.00 | 0.25 | 1.00 |
| 4000 L OX | | | | | | | | |
| (liquid form of | | | | | | | | |
| enzyme) | | | | | | | | |
| Tomadol 1-5 | 8.00 | 8.00 | 8.00 | 8.00 | 8.00 | 8.00 | 8.00 | 8.00 |
| PEG 400 | q.s | q.s | q.s | q.s | q.s | q.s | q.s | q.s |

Referring to Table 2, Compositions 1, 2, 5, and 6 represent compositions using a standard peroxide composition (Na₂CO₃*1.5H₂O₂) and an enzyme, either solid or liquid, whereas Compositions 3, 4, 7 and 8 are the compositions according to the present invention which use PVP*H₂O₂ peroxides instead of a standard peroxide composition.

To make the compositions in Table 2, the following procedure was used. First, the 1.5% Hydroxypropyl methylcellulose (Klucel HCS) in PEG 400 pre-mix was made. To make the pre-mix, first 591 grams of PEG 400 was heated to 50° C. while being stirred with a 3″ radial metal blade. Next, 9 grams of Klucel HCS was mixed into the pre-mix while being stirred to make a slight vortex. After about 1.5 hours, the speed of the stirred was increased to keep the vortex. After 2 hours, the heat was turned off but the stirring continued overnight.

Once the pre-mix was made, the final composition was prepared. First, the Klucel-PEG pre-mix was put into a beaker and stirred. Additional PEG was slowly added to the pre-mix and stirred until the additional PEG was dissolved. The PVP*H₂O₂ was then added to the mixture (it was determined that the PVP*H₂O₂ can be added before the Klucel is fully dissolved). Next, fumed silica (Cab-o-sil HS-5) was added to the mixture and stirred until fully dispersed. Tomadol 1-5 was then added and stirred until evenly mixed. After the Tomadol 1-5 was evenly mixed into the solution, percarbonate was then added and stirred until evenly distributed. Finally, the OX enzyme (either solid or liquid) was added to the solution and gently stirred until distributed; however, in this example, it is the liquid enzyme solution that was dissolved while the solid enzyme remained in suspension-like form.

### Example 2

In order to assess stability of the peroxide, the H₂O₂ level was determined through titration with 0.1 N KMnO₄ under acidic conditions. The oxidation of H₂O₂ by MnO₄⁻ is typically expressed through the reaction.

5H₂O₂(aq)+6H⁺(aq)+2MnO₄⁻→5O₂+2Mn²⁺(aq)+8H₂O

However, an equally acceptable balanced version is

H₂O₂(aq)+6H⁺(aq)+2MnO₄⁻→3O₂+2Mn²⁺(aq)+4H₂O

This equation was the relationship assumed in the calculations and is consistent with other published methods (see American Chemical Society, Reagent Chemicals, Sixth Ed., American Chemical Society, Washington, D.C. 1981, pp. 287-288).

In order to assess the stability of the enzyme, the enzyme activity was measured by a procedure adapted from a method in the literature (T. M. Rothgeb et. al., Journal of the American Oil Chemists' Society V. 65, pp. 806-810 (1988)). The method measures enzyme activity based on the ability of the enzyme to cleave the peptide N-succinyl-ala-ala-pro-phe-p-nitroanilide and release the chromophore into solution. The absorbance of the chromophore was then monitored at 410 nm as an indication of enzyme activity. Enzyme and substrate were incubated in a tris buffer for 1 hour at a temperature of 50° C. Because of the presence of peroxide, 0.04M Na₂S₂O₃ was added to the buffer solutions to act as a reducing agent. Finally, a filtering step was added, where the incubated samples were pushed through a 0.45 μm filter before taking absorbance readings.

In order to assess the stability of the compositions, the percent peroxide and percent enzyme remaining were measured over a period of 93 days. The peroxide levels were measured as a function of time as described above. Table 3 shows the levels of H₂O₂ in compositions 5-8 (in Table 2) measured at various time periods when the samples were incubated at room temperature.

TABLE 3
Peroxide levels for compositions made in Example 1

| Composition | | | | | | |
|---|---|---|---|---|---|---|
| Number | Initial | ± | Day 28 | ± | Day 93 | ± |
| 1 | 1.896 | 0.098 | 1.760 | 0.092 | Not | |
| (percarbonate) | | | | | measured | |
| 2 | 2.395 | 0.41 | 2.341 | 0.015 | Not | |
| (percarbonate) | | | | | measured | |
| 3 | 0.994 | 0.032 | 0.979 | 0.035 | Not | |
| (PVP-H₂O₂) | | | | | measured | |
| 4 | 1.017 | 0.015 | 0.958 | 0.013 | Not | |
| (PVP-H₂O₂) | | | | | measured | |
| 5 | 2.874 | 0.050 | 2.534 | 0.088 | 1.866 | 0.107 |
| (percarbonate) | | | | | | |
| 6 | 2.366 | 0.258 | 2.129 | 0.004 | 2.248 | 0.332 |
| (percarbonate) | | | | | | |
| 7 | 1.019 | 0.019 | 1.010 | 0.010 | 1.027 | 0.007 |
| (PVP-H₂O₂) | | | | | | |
| 8 | 0.967 | 0.014 | 0.967 | 0.013 | 0.950 | 0.031 |
| (PVP-H₂O₂) | | | | | | |

Values, in weight percentage, represent an average of two measurements with the error values representing the differences between upper and lower values.

Peroxide levels were fairly stable in all samples except for that of composition number 5. Interestingly, peroxide levels were fairly stable in compositions 7 and 8, having PVP-peroxide (PVP-H2O2). Thus, even though some water was added with the inclusion of the enzymes, the peroxide remained stable.

The enzyme activity was measured as a function of time as described above. Values of the percent enzyme remaining at day 28 and day 93 for samples incubated at room temperature are listed in Table 4.

TABLE 4
Enzyme activity for compositions made in Example 1

| Composition | | | | |
|---|---|---|---|---|
| Number | Day 28 | ± | Day 93 | ± |
| 1 | 85.80 | 4.62 | Not measured | |
| (percarbonate) | | | | |
| 2 | 77.28 | 2.19 | Not measured | |
| (percarbonate) | | | | |
| 3 | 137.11 | 1.85 | Not measured | |
| (PVP-H₂O₂) | | | | |
| 4 | 134.20 | 0.43 | Not measured | |
| (PVP-H₂O₂) | | | | |
| 5 | 14.26 | 0.23 | 0 | — |
| (percarbonate) | | | | |
| 6 | 4.80 | 0.75 | 0 | — |
| (percarbonate) | | | | |
| 7 | 81.57 | 1.22 | 72.60 | 9.08 |
| (PVP-H₂O₂) | | | | |
| 8 | 84.87 | 6.15 | 79.14 | 12.73 |
| (PVP-H₂O₂) | | | | |

Significant levels of enzyme remained in compositions 7 and 8, both of which contained the liquid enzyme and the PVP-H₂O₂, after 93 days. This result is quite unexpected as the enzyme was basically in a “non-protected” form, e.g., as would be offered in the form of a granule. Levels over 100% for percent enzyme remaining may have been reflective of the fact that enzymes were incorporated as dispersed particles.

Results on stability in compositions 7 and 8 imply that uniform compositions containing enzyme and peroxide could be made over a range of viscosities, e.g., from sprayable low viscosities to thick gels.

### Example 3

In order to assess the efficacy of the samples when used as pre-treaters, a detergency test using a Terg-o-tometer was used. In the procedure, a 60 mL syringe was loaded with a particular sample. Approximately 1 gram of the sample was then extruded on a 12″×12″ glass plate. A total of 7 dollops were applied to the plate. A second plate was then prepared as described. Two of each of seven different swatches, 2.5″×2.5″ were then applied to each of the sample dollops, so that one swatch was applied to each dollop (14 swatches for 14 dollops). Table 5 shows the swatch types used.

TABLE 5
Swatch types used in assessment of laundry pre-treater efficiacy

| Stain | Fabric |
|---|---|
| Blood | Cotton 400 |
| Coffee | Cotton 400 |
| EMPA 116 (blood, milk, carbon black) | Cotton 400 |
| EMPA 117 (blood, milk, carbon black) | Polyester-cotton 7435WRL |
| Grass | Cotton 400 |
| Red Wine (RW) | Cotton 400 |
| Tea | Cotton 400 |

The swatches were then wetted with deionized water. The swatches were in contact with the pre-treater for 10 minutes. The swatches were then washed in a Terg-o-tometer. All swatches were washed using A&H Essentials Liquid Laundry Detergent at a dose of 0.84 g detergent/L water. The Essentials detergent was dissolved in water in the terg buckets to make a total volume of 990 mL. The water was pre-heated to about 88° F. (the target wash temperature). The solutions in the terg buckets were then allowed to equilibrate with the terg bath to a temperature of 88±1° F. The terg timer was set at 11 minutes. The terg was started and 10 mL of 10,000 ppm (calculated as equivalent level of CaCO₃) hard water was added to each bucket. The hardness of each bucket was therefore 100 ppm. With approximately 10 minutes remaining in the wash cycle, 2 swatches of each stain (already pre-treated for 10 minutes) were added to each terg bucket (for a total of 14 swatches per bucket). Only stains that were pre-treated in one particular manner were added to the same bucket.

At the conclusion of the wash cycle, the swatches were removed from each bucket, squeezed by hand and placed on a screen. The buckets were then rinsed. To each bucket was added 990 mL of fresh deionized water along with 10 mL of 10,000 ppm water. Solutions in each bucket were mixed as before. The temperature in each bucket was then allowed to equilibrate at 88±1° F. The terg timer was set to five minutes, started, and swatches were added to each bucket. Following this rinse process, the swatches were removed, squeezed by hand, and placed on sieves.

To dry the swatches, a cap was placed on top of the sieve holding the swatches. A heat gun was then used to blow hot air up beneath and through the sieve. Drying of the swatches typically took a couple of minutes.

Stain removal was evaluated by comparing color assessments on swatches before washing and after washing. Color assessments in the CIE L*a*b*color space were performed on unwashed and washed swatches via a BYK Gardner Color-view spectrophotometer. Values of ΔE, a root mean square color difference between the swatch and a non-soiled standard swatch, were then calculated for unwashed and washed swatches according to

Before washing: ΔEᵤ=[(Lᵤ−Lₒ))²+(aᵤ−aₒ)₂+(bᵤ−bₒ)²]^{1/2}

After washing: ΔE_{w}=[(L_{w}−Lₒ)²+(a_{w}−aₒ)²+(b_{w}−bₒ)²]^{1/2}

where u, w, and o correspond to values for unwashed swatch, washed swatches, and non-stained swatches, respectively. The percent satin removal (% SR) was calculated according to:

% SR=[(ΔEᵤ−ΔE_{w})/ΔEᵤ]×100

Table 6 shows values of % SR for each system. Results were tested against the control values for significance at the 95% confidence level using a double sided student's t-test. Variability was assumed to be unknown but about equal between the compared samples.

TABLE 6
Detergency efficacy for compositions made in Example 1

| | | Average | | Significant at |
|---|---|---|---|---|
| Soil | Sample | % SR | SD | α = 0.05? |
| Cotton Blood | Control-Dry | 56.26 | 5.28 | |
| | Swatches | | | |
| Cotton Blood | 1 | 38.82 | 2.42 | Significant |
| Cotton Blood | 2 | 41.06 | 2.11 | Significant |
| Cotton Blood | 3 | 23.95 | 3.49 | Significant |
| Cotton Blood | 4 | 24.70 | 1.44 | Significant |
| Cotton Blood | 5 | 33.07 | 1.57 | Significant |
| Cotton Blood | 6 | 32.32 | 1.14 | Significant |
| Cotton Blood | 7 | 19.47 | 2.40 | Significant |
| Cotton Blood | 8 | 26.44 | 3.32 | Significant |
| Cotton Coffee | Control-Dry | 38.69 | 0.43 | |
| | Swatches | | | |
| Cotton Coffee | 1 | 52.26 | 1.48 | Significant |
| Cotton Coffee | 2 | 50.40 | 1.96 | Significant |
| Cotton Coffee | 3 | 42.17 | 0.66 | Significant |
| Cotton Coffee | 4 | 52.90 | 1.15 | Significant |
| Cotton Coffee | 5 | 46.51 | 1.79 | Significant |
| Cotton Coffee | 6 | 48.56 | 2.06 | Significant |
| Cotton Coffee | 7 | 52.42 | 1.67 | Significant |
| Cotton Coffee | 8 | 53.55 | 1.24 | Significant |
| EMPA 116 | Control-Dry | 17.09 | 2.36 | |
| | Swatches | | | |
| EMPA 116 | 1 | 39.83 | 1.63 | Significant |
| EMPA 116 | 2 | 44.75 | 0.83 | Significant |
| EMPA 116 | 3 | 10.93 | 1.50 | Significant |
| EMPA 116 | 4 | 15.07 | 1.82 | Not Significant |
| EMPA 116 | 5 | 31.37 | 1.03 | Significant |
| EMPA 116 | 6 | 35.25 | 1.35 | Significant |
| EMPA 116 | 7 | 9.31 | 2.10 | Significant |
| EMPA 116 | 8 | 10.44 | 2.29 | Significant |
| EMPA 117 | Control-Dry | 13.31 | 0.72 | |
| | Swatches | | | |
| EMPA 117 | 1 | 66.11 | 3.48 | Significant |
| EMPA 117 | 2 | 60.92 | 3.67 | Significant |
| EMPA 117 | 3 | 22.05 | 1.14 | Significant |
| EMPA 117 | 4 | 25.13 | 2.62 | Significant |
| EMPA 117 | 5 | 41.41 | 1.01 | Significant |
| EMPA 117 | 6 | 46.44 | 0.51 | Significant |
| EMPA 117 | 7 | 20.49 | 2.13 | Significant |
| EMPA 117 | 8 | 25.96 | 2.45 | Significant |
| Cotton Grass | Control-Dry | 11.33 | 0.46 | |
| | Swatches | | | |
| Cotton Grass | 1 | 77.32 | 2.25 | Significant |
| Cotton Grass | 2 | 76.71 | 1.16 | Significant |
| Cotton Grass | 3 | 61.67 | 0.60 | Significant |
| Cotton Grass | 4 | 65.14 | 2.16 | Significant |
| Cotton Grass | 5 | 71.36 | 0.52 | Significant |
| Cotton Grass | 6 | 73.90 | 2.02 | Significant |
| Cotton Grass | 7 | 64.74 | 0.94 | Significant |
| Cotton Grass | 8 | 69.95 | 1.07 | Significant |
| Cotton Red | Control-Dry | 19.54 | 1.04 | |
| Wine | Swatches | | | |
| Cotton Red | 1 | 25.59 | 0.65 | Significant |
| Wine | | | | |
| Cotton Red | 2 | 23.19 | 1.46 | Significant |
| Wine | | | | |
| Cotton Red | 3 | 43.75 | 0.98 | Significant |
| Wine | | | | |
| Cotton Red | 4 | 41.96 | 0.85 | Significant |
| Wine | | | | |
| Cotton Red | 5 | 20.99 | 1.44 | Not Significant |
| Wine | | | | |
| Cotton Red | 6 | 22.20 | 0.91 | Significant |
| Wine | | | | |
| Cotton Red | 7 | 44.10 | 0.73 | Significant |
| Wine | | | | |
| Cotton Red | 8 | 44.23 | 0.20 | Significant |
| Wine | | | | |
| Cotton Tea | Control-Dry | −8.31 | 1.76 | |
| | Swatches | | | |
| Cotton Tea | 1 | 9.19 | 1.61 | Significant |
| Cotton Tea | 2 | 6.70 | 2.09 | Significant |
| Cotton Tea | 3 | 23.86 | 1.70 | Significant |
| Cotton Tea | 4 | 26.19 | 1.58 | Significant |
| Cotton Tea | 5 | 1.27 | 1.33 | Significant |
| Cotton Tea | 6 | 3.53 | 2.99 | Significant |
| Cotton Tea | 7 | 25.08 | 1.17 | Significant |
| Cotton Tea | 8 | 26.68 | 1.99 | Significant |

In most cases, use of the experimental systems enhanced cleaning. In the case of dried blood, it is well known that depending on the state of the blood (fresh or dried), results can be highly variable, especially when exposed to peroxide.

### Example 4

The compositions in Example 4 highlight systems which contain 1,2-butanediol as the solvent, granular or liquid form of enzyme, and sodium percarbonate or polyvinyl pyrrolidone-hydrogen peroxide as the oxidizing bleach.

Compositions similar to those in Example 1, with PEG 400 replaced by 1,2-butanediol were prepared. Detergency efficacy was assessed as described in Example 3. Results are shown in Table 7.

TABLE 7
Detergency efficacy for compositions made with 1, 2-butanediol

| | | Average | | Significant at |
|---|---|---|---|---|
| Soil | Sample | % SR | SD | α = 0.05? |
| Cotton Blood | Control-Dry | 51.46 | 1.02 | |
| | Swatches | | | |
| Cotton Blood | 1 | 30.61 | 0.64 | Significant |
| Cotton Blood | 2 | 32.13 | 1.09 | Significant |
| Cotton Blood | 3 | 29.76 | 0.58 | Significant |
| Cotton Blood | 4 | 27.82 | 1.71 | Significant |
| Cotton Blood | 5 | 26.59 | 2.36 | Significant |
| Cotton Blood | 6 | 25.84 | 1.02 | Significant |
| Cotton Blood | 7 | 27.22 | 0.74 | Significant |
| Cotton Blood | 8 | 31.15 | 1.33 | Significant |
| Cotton Coffee | Control-Dry | 39.93 | 1.75 | |
| | Swatches | | | |
| Cotton Coffee | 1 | 49.02 | 2.71 | Significant |
| Cotton Coffee | 2 | 47.47 | 1.95 | Significant |
| Cotton Coffee | 3 | 53.07 | 0.74 | Significant |
| Cotton Coffee | 4 | 53.96 | 1.34 | Significant |
| Cotton Coffee | 5 | 45.33 | 2.08 | Significant |
| Cotton Coffee | 6 | 49.39 | 2.81 | Significant |
| Cotton Coffee | 7 | 53.30 | 1.42 | Significant |
| Cotton Coffee | 8 | 54.48 | 0.78 | Significant |
| EMPA 116 | Control-Dry | 17.95 | 2.32 | |
| | Swatches | | | |
| EMPA 116 | 1 | 31.73 | 2.90 | Significant |
| EMPA 116 | 2 | 38.26 | 0.46 | Significant |
| EMPA 116 | 3 | 16.51 | 2.67 | Not Significant |
| EMPA 116 | 4 | 17.86 | 1.61 | Not Significant |
| EMPA 116 | 5 | 4.81 | 1.15 | Significant |
| EMPA 116 | 6 | 7.98 | 1.55 | Significant |
| EMPA 116 | 7 | 14 .85 | 2.55 | Not Significant |
| EMPA 116 | 8 | 13.21 | 1.82 | Significant |
| EMPA 117 | Control-Dry | 13.45 | 1.29 | |
| | Swatches | | | |
| EMPA 117 | 1 | 46.40 | 3.37 | Significant |
| EMPA 117 | 2 | 59.11 | 3.12 | Significant |
| EMPA 117 | 3 | 27.75 | 2.13 | Significant |
| EMPA 117 | 4 | 32.72 | 1.35 | Significant |
| EMPA 117 | 5 | 10.97 | 1.78 | Not Significant |
| EMPA 117 | 6 | 13.31 | 2.09 | Not Significant |
| EMPA 117 | 7 | 23.89 | 1.96 | Significant |
| EMPA 117 | 8 | 25.44 | 0.48 | Significant |
| Cotton Grass | Control-Dry | 11.06 | 1.46 | |
| | Swatches | | | |
| Cotton Grass | 1 | 74.11 | 2.58 | Significant |
| Cotton Grass | 2 | 74.73 | 0.78 | Significant |
| Cotton Grass | 3 | 65.44 | 2.34 | Significant |
| Cotton Grass | 4 | 65.10 | 2.79 | Significant |
| Cotton Grass | 5 | 58.95 | 2.16 | Significant |
| Cotton Grass | 6 | 60.01 | 0.95 | Significant |
| Cotton Grass | 7 | 66.23 | 3.04 | Significant |
| Cotton Grass | 8 | 68.32 | 1.49 | Significant |
| Cotton Red | Control-Dry | 20.04 | 0.93 | |
| Wine | Swatches | | | |
| Cotton Red | 1 | 23.85 | 1.74 | Significant |
| Wine | | | | |
| Cotton Red | 2 | 20.71 | 2.06 | Not Significant |
| Wine | | | | |
| Cotton Red | 3 | 44.14 | 1.01 | Significant |
| Wine | | | | |
| Cotton Red | 4 | 44.01 | 0.90 | Significant |
| Wine | | | | |
| Cotton Red | 5 | 21.59 | 2.49 | Not Significant |
| Wine | | | | |
| Cotton Red | 6 | 23.09 | 1.20 | Significant |
| Wine | | | | |
| Cotton Red | 7 | 44.08 | 0.97 | Significant |
| Wine | | | | |
| Cotton Red | 8 | 44.48 | 0.85 | Significant |
| Wine | | | | |
| Cotton Tea | Control-Dry | −5.48 | 0.99 | |
| | Swatches | | | |
| Cotton Tea | 1 | 5.86 | 2.58 | Significant |
| Cotton Tea | 2 | 4.56 | 2.16 | Significant |
| Cotton Tea | 3 | 26.41 | 1.29 | Significant |
| Cotton Tea | 4 | 25.75 | 0.46 | Significant |
| Cotton Tea | 5 | 3.35 | 3.36 | Significant |
| Cotton Tea | 6 | 4.67 | 4.73 | Significant |
| Cotton Tea | 7 | 23.58 | 2.63 | Significant |
| Cotton Tea | 8 | 27.63 | 1.44 | Significant |

Again, cleaning efficacy was improved compared to the control, demonstrating that 1,2-butanediol could be used as a solvent in the present invention.

### Example 5

The compositions in Example 5 highlight systems which possess viscosities lower, and thus having a more liquid-like consistency, than the previous examples, which were more gel-like. These systems could be delivered via spraying or squirting. All compositions contained amylase in addition to the OX protease. Some variants contained solvent (Dowanol DPnB) or liquid H₂O₂ (Eka PB 33).

Exemplary embodiments of the more liquid-like laundry detergent compositions of the present invention, with each of the components set forth in weight percent actives (i.e., theoretical amounts after blending), are shown in Table 8.

TABLE 8
Compositions with lower viscosities.

| Composition | | | |
|---|---|---|---|
| Number | 1 | 2 | 3 |
| Fumed Silica | 0.20 | 0.20 | 0.20 |
| (Cab-o-sil HS-5) | | | |
| Hydroxypropyl | 0.15 | 0.15 | 0.15 |
| methylcellulose | | | |
| (Klucel MCS) | | | |
| PVP*H₂O₂ | 5.60 | 0 | 5.60 |
| (Peroxydone K- | | | |
| 30), about 18% | | | |
| H₂O₂ | | | |
| H₂O₂ (from Eka, | 0 | 1.00 | 0 |
| PB33) | | | |
| Liquid protease | 1.00 | 1.00 | 1.00 |
| (Purafect OX | | | |
| 4000 L) | | | |
| Liquid amylase | 1.00 | 1.00 | 1.00 |
| (Purastar HP AM | | | |
| 5000 L) | | | |
| Tomadol 1-5 | 8.00 | 8.00 | 8.00 |
| Triethanolamine | 1.20 | 1.20 | 1.20 |
| (TEA) | | | |
| Dowanol TPnB | 0 | 0 | 1.00 |
| PEG 400 | 82.85 | 85.93 | 81.85 |
| Water (due to | 0 | 2.73 | 0 |
| H₂O₂) | | | |

Formulas of compositions 1 and 3 were completely anhydrous while composition 2 contained a small amount of water which was added with the PB33 H₂O₂ (about 60% water in PB33).

The following procedure was used for making the compositions in Table 8. First, a Klucel-PEG pre-mix was made according to the procedure described in Example 1. Additional PEG was slowly added to the pre-mix and stirred until dissolved. Peroxydone, which can be added before the Klucel is fully dissolved, or PB33 peroxide, was then added to the solution. Next, the fumed silica (Cab-o-sil HS-5) was added to the mixture and the mixture was stirred until fully dispersed. After the fumed silica was fully dispersed in the mixture, a dihydroxyethyl tallow glycinate (Makam TM), which may have to be heated since TM is thick, was added to the mixture. After the Makam TM was added, Dowanol TPnB was added to the mixture. Next, liquid protease was added to the mixture and gently stirred until distributed. Finally the liquid amylase was added to the mixture.

Efficacy of the compositions was assessed in a washing machine study. Each composition was employed as a pre-treater on swatches attached to a larger fabric substrate. The products were applied to the various stain types without wetting with water and gently rubbed. The pre-treat time was ten minutes. The test swatches were then washed in a top-load machine at 88° F. using 100 ppm hardness (expressed as CaCO3) water. All washes were performed using Arm &Hammer 2× liquid detergent (47.8 g/load). Results are shown in Table 9. Indications of significance compared with the control are shown as “+” (significantly better), “−” significantly worse), or “=” (same).

TABLE 9
Detergency efficacy for lower viscosity compositions.

| Stain/Soil | Fabric | Control | Comp. 1 | | Comp. 2 | | Comp. 3 | | LSD |
|---|---|---|---|---|---|---|---|---|---|
| Grass | Cotton | 26.9 | 73.6 | + | 72.5 | + | 76.0 | + | 3.2 |
| Coffee | Cotton | 52.7 | 57.6 | + | 62.3 | + | 58.7 | + | 3.6 |
| Makeup | Cotton | 42.3 | 51.9 | + | 48.3 | + | 48.9 | + | 4.9 |
| EMPA 112 | Cotton | 26.5 | 59.6 | + | 51.9 | + | 61.9 | + | 5.7 |
| Red Wine | Cotton | 66.1 | 71.1 | + | 75.9 | + | 73.6 | + | 3.0 |
| Choc Ice | Cotton | 67.7 | 78.0 | + | 78.2 | + | 80.7 | + | 3.7 |
| Cream | | | | | | | | | |
| Mustard | Cotton | 21.7 | 35.5 | + | 34.2 | + | 37.6 | + | 2.9 |
| Blueberry | Cotton | 68.7 | 76.9 | + | 79.0 | + | 81.6 | + | 2.4 |
| Blood | Cotton | 61.5 | 52.2 | − | 42.9 | − | 60.2 | = | 5.0 |
| EMPA 117 | PolyCotton | 24.0 | 42.7 | + | 36.7 | + | 46.5 | + | 4.4 |
| Tea | Cotton | 13.5 | 18.3 | = | 26.8 | + | 16.8 | = | 6.8 |
| Spaghetti | Cotton | 89.6 | 88.3 | = | 88.6 | = | 74.7 | − | 7.4 |
| Sauce | | | | | | | | | |
| EMPA 161 | Cotton | 6.0 | 50.4 | + | 54.2 | + | 52.8 | + | 4.6 |
| Chocolate | Cotton | 73.3 | 91.6 | + | 90.3 | + | 92.7 | + | 1.6 |
| Pudding | | | | | | | | | |
| Perspiration | Cotton | 79.3 | 82.7 | + | 82.4 | + | 85.7 | + | 2.3 |
| Barbecue | Cotton | 74.1 | 84.4 | + | 86.4 | + | 87.2 | + | 2.8 |
| Sauce | | | | | | | | | |
| Frenchs | Cotton | 49.2 | 76.2 | + | 75.4 | + | 82.8 | + | 4.0 |
| Brown | | | | | | | | | |
| Total Stains | | 843.4 | 1091.0 | | 1086.0 | | 1118.6 | | |
| Dust Sebum | Cotton | 45.3 | 64.2 | + | 63.3 | + | 66.7 | + | 3.7 |
| Standard Soil | Cotton | 24.0 | 48.0 | + | 49.1 | + | 43.1 | + | 7.6 |
| EMPA 101 | Cotton | 17.1 | 22.9 | + | 21.9 | + | 24.2 | + | 3.0 |
| Clay | Cotton | 56.0 | 57.3 | = | 49.6 | − | 57.8 | = | 3.2 |
| Dust Sebum | PolyCotton | 49.5 | 79.9 | + | 79.9 | + | 81.7 | + | 2.0 |
| Motor Oil | Cotton | 7.4 | 19.4 | + | 22.2 | + | 19.8 | + | 2.1 |
| Beef/Tallow | Cotton | 58.7 | 81.0 | + | 80.6 | + | 83.6 | + | 3.6 |
| Total Soils | | 257.9 | 372.7 | | 366.7 | | 376.8 | | |
| Whiteness | | | | | | | | | |
| Index | | | | | | | | | |
| Delta b | | −2.95 | −2.12 | − | −2.72 | − | −2.17 | − | 0.12 |
| Delta WIE | | 13.68 | 9.80 | − | 12.58 | − | 10.08 | − | 0.66 |
| pH (10 min. | | 7.43 | 7.63 | | 7.46 | | 7.63 | | |
| into wash | | | | | | | | | |
| Total | | 1101.3 | 1463.7 | | 1452.7 | | 1495.4 | | |
| (stain + soil) | | | | | | | | | |
| AverageStain | | 49.6 | 64.2 | + | 63.9 | + | 65.8 | + | 4.0 |
| Removal | | | | | | | | | |
| Average Soil | | 36.8 | 53.2 | + | 52.4 | + | 53.8 | + | 3.6 |
| Removal | | | | | | | | | |

In most cases, stain removal was improved by use of the pre-treat systems. Composition 3 appeared to show better performance on dried blood compared to compositions 1 and 2. The compositions in Example 5 demonstrate that liquids made according to the present invention can have lower viscosities while improving stain removal.

### Example 6

In order to assess stability of the peroxide and the enzymes of the compositions described in Example 5, the H₂O₂ level and enzyme levels were determined according to the procedures described in Example 2.

In order to assess the stability of the compositions, the percent peroxide and percent enzyme remaining were measured over a period of 46 days. The peroxide levels were measured as a function of time as described in Example 2. Table 10 shows the levels of H₂O₂ measured at various time periods for samples incubated at room temperature of compositions 1-3 in Table 8.

TABLE 10
Peroxide levels for compositions made in Example 5

| Composition | | | | | | |
|---|---|---|---|---|---|---|
| Number | Day 1 | ± | Day 13 | ± | Day 46 | ± |
| 1 | 1.06 | 0.03 | 0.85 | 0 | 0.83 | 0 |
| (PVP-H₂O₂) | | | | | | |
| 2 | 1.09 | 0 | 0.87 | 0.01 | 0.75 | 0.02 |
| (H₂O₂ from | | | | | | |
| Eka, PB33) | | | | | | |
| 3 | 1.06 | 0.01 | 0.78 | 0.01 | 0.69 | 0 |
| (PVP-H₂O₂) | | | | | | |

Peroxide values were more stable in composition 1, with a slower decrease in H₂O₂ between days 13 and 46 (compared with the interval between day 1 and 13). Stability was slightly worse in samples 2 and 3. It is interesting that sample 2, containing a slight amount of water maintained a degree of peroxide stability over the 46 day period.

Enzyme activity over time was measured according to the procedure described in Example 2. Values of the percent enzyme remaining at days 1, 13 and 46 for samples incubated at room temperature are listed in Table 11.

TABLE 11
Enzyme activity for compositions made in Example 5

| Composition | | | | | | |
|---|---|---|---|---|---|---|
| Number | Day 1 | ± | Day 13 | ± | Day 46 | ± |
| 1 | 114.98 | 0.70 | 114.53 | 2.03 | 110.91 | 7.11 |
| (PVP-H₂O₂) | | | | | | |
| 2 | 116.95 | 2.06 | 118.57 | 4.50 | 81.33 | 7.47 |
| (H₂O₂ from | | | | | | |
| Eka, PB33) | | | | | | |
| 3 | 100.89 | 3.68 | 100.55 | 3.58 | 73.52 | 6.29 |
| (PVP-H₂O₂) | | | | | | |

Enzyme activities were maintained at a surprising level, considering the anhydrous or near-ahydrous environment and the inclusion of peroxide. Only slight reductions were seen from days 13 to 46, even in sample 2, which contained liquid H₂O₂.

1. A liquid detergent composition comprising:
a) an adduct of a peroxide and an organic material selected from polyvinylpyrrolidone peroxide and urea-hydrogen peroxide-polyvinylpyrrolidone;
b) at least one detersive enzyme in the amount of 0.25 to 5% by weight of the overall composition; and
c) a solvent selected from polyethylene glycol, 1,2-butanediol, 1,2-hexanediol, and ethylene glycol monobutyl ether,
wherein said peroxide component and detersive enzyme are dissolved in said solvent.

2. The composition of claim 1 wherein the liquid is clear and uniform.

3. (canceled)

4. (canceled)

5. (canceled)

6. The composition of claim 1 wherein the detersive enzyme is protease, lipase, amylase, or combinations thereof.

7. The composition of claim 1 wherein the solvent is anhydrous.

8. The composition of claim 1 wherein the solvent is a material which lies within a sphere in the Hansen space, defined by a radius between 15 to 30 (MPa)^{1/2}.

9. The composition of claim 1 wherein the solvent is a material which lies within a sphere in the Hansen space, defined by a radius between 20 to 25 (MPa)^{1/2}.

10. (canceled)

11. The composition of claim 1 wherein the viscosity of the composition is less than 5000 cps.

12. The composition of claim 1 wherein the water content of said composition is 0.001 to 10%.

13. The composition of claim 1 further comprising a surfactant and a thickening agent.

14. The composition of claim 13 wherein said thickening agent is selected from the group consisting of fatty acid, cross-linked acrylic acid copolymer, colloidal silica, carboxymethylcellulose, polyvinyl alcohol, polyvinyl pyrrolidone and sodium polyacrylate and a mixture thereof.

15. The composition of claim 14 wherein the colloidal silica is a hydrophilic fumed silica.

16. A stable uniform liquid detergent comprising:
a) polyvinylpyrrolidone peroxide;
b) a detersive enzyme wherein the enzyme is protease, lipase, amylase, or combinations thereof in the amount of 0.25 to 5% by weight of the overall composition; and
c) polyethylene glycol solvent or 1,2-butanediol solvent,
wherein the peroxide and enzyme are fully dissolved in said solvent.

17. The composition of claim 16 wherein the viscosity of the composition is less than 5000 cps.

18. The composition of claim 16 wherein the weight percentage of said peroxide is 0.001 to 20 wt. % of the overall composition.

19. (canceled)
